(19) United States
(12) Patent Application Publication
(10) Pub. No.: US 2007/0218864 A1
(43) Pub. Date: Sep. 20, 2007

(54) Wireless communication system, wireless communication terminal, wireless base station, method of determining number of simultaneous connections, and program for wireless communication system

(75) Inventor: Ryuichi Toshida, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/724,335

(22) Filed: Mar. 15, 2007

(30) Foreign Application Priority Data
Mar. 16, 2006 (JP) 073265/2006

(51) Int. Cl. H04Q 7/20

(52) U.S. Cl. 455/403

(57) ABSTRACT

The unusable part of the simultaneous connection capacity is reduced by more flexibly using the simultaneous connection capacity of the wireless base station to increase the number of wireless transmission terminals to be simultaneously connected to the base station while maintaining the predetermined communication quality when the transmission rate is dynamically changing moment by moment. Based on the codec type of the transmission terminal associated with the base station for each transmission rate and the number of terminals using codecs of the type, the base station calculates the band to be used at a point of time for each transmission rate. The available traffic for a transmission rate can be estimated by subtracting the band from an associated effective rate. The base station determines grant or rejection for connection depending on whether or not the communication state is within the allowance range in which a terminal is additionally connectable for communication using at least one transmission rate.

### BACKGROUND OF THE INVENTION

1. Field of the Invention

The present invention relates to a wireless communication system, a wireless base station, a wireless communication terminal, a transmission rate determining method, a method of determining number of simultaneous connections, and a program for wireless communication system for supporting a plurality of transmission rates in wireless communication, for example, on a wireless Local Area Network (LAN).

2. Description of the Related Art

A wireless communication system such as a wireless LAN, has carried out multi-rate communication in which a plurality of transmission rates is supported.

For example, Institute of IEEE802.11b standard prescribes four transmission rates including 11, 5.5, and 2 Megabits and one Megabit per second (Mbps) for the wireless LAN. IEEE802.11a standard stipulates eight transmission rates, namely, 54, 48, 36, 24, 18, 12, 9, and 6 Mbps in which 54, 48, 36, 28, and 9 Mbps are optional.

The multi-rate communication has a basic aspect that if the transmission rate becomes lower, the communicable distance can be elongated. Therefore, as shown in FIG. 1, the wireless base station communicates with a nearby wireless terminal at a higher transmission rate. For farther wireless terminals, the base station uses a lower transmission rate, thereby conducting efficient wireless communication in a wide area.

In general, when the transmission rate dynamically varies in the multi-rate communication, it is difficult to correctly calculate a band to be employed or occupied for each communication. Therefore, to secure the quality of sound and voice in the wireless communication especially when a wireless audio terminal is utilized, there has been used a method to fix a transmission rate or a method to fix the maximum number of simultaneous connections.

The maximum number of simultaneous connections that is controlled by the wireless base station, and the transmission rates to be allocated for communication are in general determined beforehand based on experiences.

For example, document 1 (Japanese Patent Application Laid-Open No. 10-13949) describes an automatic regulation method of a wireless base station in a mobile communication system. In the method, the base station measures traffic in unit time. If the measured value exceeds a threshold value, the base station regulates transmission of portable terminals.

Document 2 (Japanese Patent Application Laid-Open No. 11-355829) describes a technique wherein if the quality of a call received from a wireless communication terminal by a receiver of a wireless base station under consideration is less than the reference call quality, the reference intensity of electric wave is changed from the predetermined first value to the predetermined second value. The wave level after the change is notified to the wireless communication terminal. The terminal then measures intensity of an electric wave received from another wireless base station to thereby control the handover operation.

However, the maximum number of simultaneous connections to be accommodated by one wireless base station needs to secure the communication quality even if the communication environment changes in various ways. Therefore, the simultaneous connection capacity of a wireless base station cannot be fully used in most cases.

That is, even if a base station could communicate with more mobile terminals simultaneously, the base station would refuse further wireless terminals when simultaneous connections reached the predetermined maximum number.

FIG. 1 shows that when the maximum number of simultaneous connections is six, the seventh terminal cannot be connected to the base station.

Therefore, it has been required to increase the number of simultaneous connections of wireless communication terminals by more flexibly using the simultaneous connection capacity of a wireless base station.

According to document 1, the traffic is measured for the overall wireless interval and if the measured value exceeds the threshold value, the transmission is regulated. However, consideration has not been given to a situation wherein the connection is controlled to keep the predetermined communication quality when the transmission rate is dynamically changing in the multi-rate communication system.

Document 2 discloses that when the call quality lowers, the reference value of electric wave intensity is reduced. Moreover, as a result of wave intensity measurement by the wireless communication terminal, if there exists a second wireless base station with higher wave intensity, the handover takes place to prevent abrupt disconnection. That is, consideration has not been given to an operation in which when the transmission rate is dynamically changing moment by moment in the multi-rate communication system, the number of simultaneous connections is increased while the predetermined communication quality is maintained.

### SUMMARY OF THE INVENTION

In view of the foregoing problems, the present invention aims to provide a wireless communication system, a wireless communication terminal, a wireless base station, a method for determining maximum number of simultaneous connections, and a program for wireless communication system that more flexibly use the simultaneous connection capacity of the wireless base station, the unused simultaneous connection capacity is reduced so that the base station simultaneously communicates with more wireless transmission terminals while maintaining the predetermined communication quality even when the transmission rate is dynamically changing.

In accordance with a first aspect of the present invention, there is provided a wireless communication system including wireless base stations each controlling connection for wireless communication with wireless communication terminals, and a system control unit for conducting various control operations for the communication in the base stations, the system supporting a plurality of transmission rates. The system includes a communication state acquiring module for continuously acquiring a wireless communication state for each of the transmission rates and a connection grant decision module for determining, based on the wireless communication state acquired by the communication state acquiring module, grant or rejection of connection for a wireless communication terminal.

It is preferable that the communication state acquiring module acquires at least information of traffic for each transmission rate in the wireless base station and the connection grant decision section determines, based on the information of traffic, grant or rejection of connection for the wireless communication terminal.

Preferably, the connection grant decision module determines, based on whether the information of traffic is equal to or less than a connectibility threshold value beforehand determined for at least one transmission rate, grant or rejection of connection for the wireless communication terminal.

It is desirable that the communication state acquiring module calculates an amount of transmission data per second for each transmission rate by use of an amount of transmission data per second of each wireless communication terminal belonging to one wireless base station and a number of wireless communication terminals belonging to the wireless base station with the amount of transmission data per second and the connection grant decision module determines, based on the amount of transmission data per second for each transmission rate and an effective rate beforehand determined for each transmission rate, grant or rejection of connection for the wireless communication terminal.

Preferably, the wireless communication system further includes a communication quality keeping module for acquiring, from the communication state acquiring module, information of communication quality in communication established in advance and conducting a changeover of connection according to the information of communication quality.

The communication quality keeping module desirably conducts a changeover of connection to a second connectable base station if the information of communication quality indicates quality lower than predetermined quality and lowers the transmission rate for the connection or disconnects the connection if the information of communication quality indicates quality lower than predetermined quality and there does not exists any connectable second wireless base station.

The communication quality information preferably includes information of sound and voice in a call using sound and voice.

The communication quality information desirably includes information of wave intensity of electric waves received from a wireless communication terminal.

It is preferably that the communication quality information includes information of traffic in the wireless base station.

Preferably, the wireless communication system further includes a warning transmitting module for transmitting, if the information of communication quality lowers to predetermined quality, warning notifying information to a wireless communication terminal conducting wireless communication with the communication quality.

In accordance with a second aspect of the present invention, there is provided a wireless communication terminal including a warning notifying module for conducting warning notification if the warning notifying information is received from the warning transmitting module in accordance with the first aspect of the present invention.

In accordance with a third aspect of the present invention, there is provided a wireless base station for supporting a plurality of transmission rates and controlling wireless communication connection with a wireless communication terminal. The base station includes a communication state acquiring module for continuously acquiring a wireless communication state for each of the transmission rates and a connection grant decision module for determining, based on the wireless communication state, grant or rejection of connection for a wireless communication terminal.

It is desirable that the communication state acquiring module acquires at least information of traffic for each transmission rate in the wireless base station and the connection grant decision module determines, based on the information of traffic, grant or rejection of connection for the wireless communication terminal.

Preferably, the connection grant decision module determines, based on whether the information of traffic is equal to or less than a connectibility threshold value beforehand determined for at least one transmission rate, grant or rejection of connection for the wireless communication terminal.

It is preferable that the communication state acquiring module calculates an amount of transmission data per second for each transmission rate by use of an amount of transmission data per second of each wireless communication terminal belonging to the wireless base station and a number of wireless communication terminals belonging to the wireless base station with the amount of transmission data per second and the connection grant decision module determines, based on the amount of transmission data per second for each transmission rate and an effective rate beforehand determined for each transmission rate, grant or rejection of connection for the wireless communication terminal.

Preferably, the wireless base station further includes a communication quality keeping module for acquiring, from the communication state acquiring module, information of communication quality in communication established in advance and conducting a changeover of connection according to the information of communication quality.

The communication quality keeping module desirably conducts a changeover of connection to a second connectable base station if the information of communication quality indicates quality lower than predetermined quality and lowers the transmission rate for the connection or disconnects the connection if the information of communication quality indicates quality lower than predetermined quality and there does not exists any connectable second wireless base station.

The communication quality information preferably includes information of sound and voice in a call using sound and voice.

The communication quality information desirably includes information of wave intensity of electric waves received from a wireless communication terminal.

The communication quality information preferably includes information of traffic in the wireless base station.

It is preferable that the wireless base station further includes a warning transmitting module for transmitting, if the information of communication quality lowers to predetermined quality, warning notifying information to a wireless communication terminal conducting wireless communication with the communication quality.

In accordance with a fourth aspect of the present invention, there is provided a method of determining number of simultaneous connections for use with a wireless communication system including wireless base stations each of which controls connection for wireless communication with wireless communication terminals, and a system control unit for conducting various control operations for the communication in the base stations, the system supporting a plurality of transmission rates. The method includes a communication state acquiring step of continuously acquiring a wireless communication state for each of the transmission rates and a connection grant decision step of determining, based on the wireless communication state acquired in the communication state acquiring step, grant or rejection of connection for a wireless communication terminal.

It is preferable that the communication state acquiring step includes acquiring at least information of traffic for each transmission rate in the wireless base station and the connection grant decision step includes determining, based on the information of traffic acquired in the communication state acquiring step, grant or rejection of connection for the wireless communication terminal.

The connection grant decision step desirably includes determining, based on whether the information of traffic is equal to or less than a connectibility threshold value beforehand determined for at least one transmission rate, grant or rejection of connection for the wireless communication terminal.

It is desirable that the communication state acquiring step includes calculating an amount of transmission data per second for each transmission rate by use of an amount of transmission data per second of each wireless communication terminal belonging to one wireless base station and a number of wireless communication terminals belonging to the wireless base station with the amount of transmission data per second and the connection grant decision step includes determining, based on the amount of transmission data per second for each transmission rate and an effective rate beforehand determined for each transmission rate, grant or rejection of connection for the wireless communication terminal.

It is preferable that the method further includes a communication quality keeping step of acquiring information of communication quality in communication established in advance and a communication quality keeping step of conducting a changeover of connection according to the information of communication quality.

It is preferable that the communication quality keeping step includes conducting a changeover of connection to a second connectable base station if the information of communication quality indicates quality lower than predetermined quality and lowering the transmission rate for the connection or disconnecting the connection if the information of communication quality indicates quality lower than predetermined quality and there does not exists any connectable second wireless base station.

The communication quality information preferably includes information of sound and voice in a call using sound and voice.

The communication quality information desirably includes information of wave intensity of electric waves received from a wireless communication terminal.

It is preferable that the communication quality information includes information of traffic in the wireless base station.

It is desirable that the method further includes a warning transmitting step of transmitting, if the information of communication quality acquired in the communication state acquiring step lowers to predetermined quality, warning notifying information to a wireless communication terminal conducting wireless communication with the communication quality.

In accordance with a fifth aspect of the present invention, there is provided a computer program for use with a wireless communication system including wireless base stations each controlling connection for wireless communication with wireless communication terminals and a system control unit for conducting various control operations for the communication in the base stations, the system supporting a plurality of transmission rates. The program makes a computer execute communication state acquiring processing for continuously acquiring a wireless communication state for each of the transmission rates and connection grant decision processing for determining, based on the wireless communication state acquired by the communication state acquiring processing, grant or rejection of connection for a wireless communication terminal.

It is desirable that the communication state acquiring processing includes acquiring at least information of traffic for each transmission rate in the wireless base station and the connection grant decision processing includes determining, based on the information of traffic acquired by the communication state acquiring processing, grant or rejection of connection for the wireless communication terminal.

The connection grant decision processing preferably includes determining, based on whether the information of traffic is equal to or less than a connectibility threshold value beforehand determined for at least one transmission rate, grant or rejection of connection for the wireless communication terminal.

It is preferable that the communication state acquiring processing includes calculating an amount of transmission data per second for each transmission rate by use of an amount of transmission data per second of each wireless communication terminal belonging to one wireless base station and a number of wireless communication terminals belonging to the wireless base station with the amount of transmission data per second and the connection grant decision processing includes determining, based on the amount of transmission data per second for each transmission rate and an effective rate beforehand determined for each transmission rate, grant or rejection of connection for the wireless communication terminal.

Preferably, the computer program further causes a computer to perform communication quality keeping processing for acquiring information of communication quality in communication established in advance and communication quality keeping processing for conducting a changeover of connection according to the information of communication quality.

The communication quality keeping processing desirably includes conducting a changeover of connection to a second connectable base station if the information of communication quality indicates quality lower than predetermined quality and lowering the transmission rate for the connection or disconnecting the connection if the information of communication quality indicates quality lower than predetermined quality and there does not exists any connectable second wireless base station.

The communication quality information desirably includes information of sound and voice in a call using sound and voice.

The communication quality information favorably includes information of wave intensity of electric waves received from a wireless communication terminal.

It is preferable that the communication quality information includes information of traffic in the wireless base station.

Preferably, the computer program further causes a computer to perform warning transmitting processing for transmitting, if the information of communication quality acquired in the communication state acquiring processing lowers to predetermined quality, warning notifying information to a wireless communication terminal conducting wireless communication with the communication quality.

In accordance with the present embodiments, the simultaneous connection capacity of the wireless base station is more flexibly utilized to reduce an unused part of the simultaneous connection capacity and hence the number of wireless transmission terminals simultaneously connectable to the base station is increased with the predetermined communication quality kept unchanged when the transmission rate is dynamically varying moment by moment.

### BRIEF DESCRIPTION OF THE DRAWINGS

The objectives and features of the present invention will become more apparent from the consideration of the following detailed description taken in conjunction with the accompanying drawings in which:

FIG. 1 is a diagram showing an example of the conventional multi-rate communication;

FIG. 2 is a block diagram showing an example of structure of a wireless communication system;

FIG. 3 is a schematic diagram showing an example of allocation of transmission routes or paths based on distance;

FIG. 4 is a block diagram showing an example of structure of a wireless base station 2 of the wireless communication system;

FIG. 5 is a block diagram showing an example of a configuration of a wireless communication terminal 3;

FIG. 6 is a flowchart showing a communication connecting operation in the wireless communication system;

FIG. 7 is a table showing an example of a relationship between codecs and bands used for communication;

FIG. 8 is a table to explain an example of an operation to determine an effective transmission rate for each transmission rate;

FIG. 9 is a diagram showing an example of a transmission rate decision table 24a;

FIG. 10 is a flowchart showing an operation to connect communication after connection is established; and

FIG. 11 is a diagram showing an example of a warning notification screen on the wireless communication terminal 3.

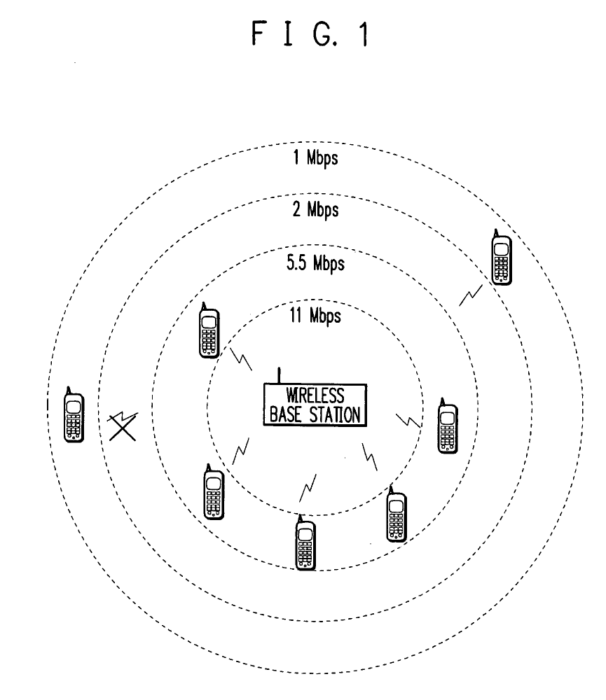

### DESCRIPTION OF THE EXEMPLARY EMBODIMENTS

Referring next to the drawings, description will be given in detail of an exemplary embodiment. A wireless communication system, a wireless communication terminal, a wireless base station, a method for determining number of simultaneous connections, and a program for wireless communication system are applied to a system such as a wireless LAN.

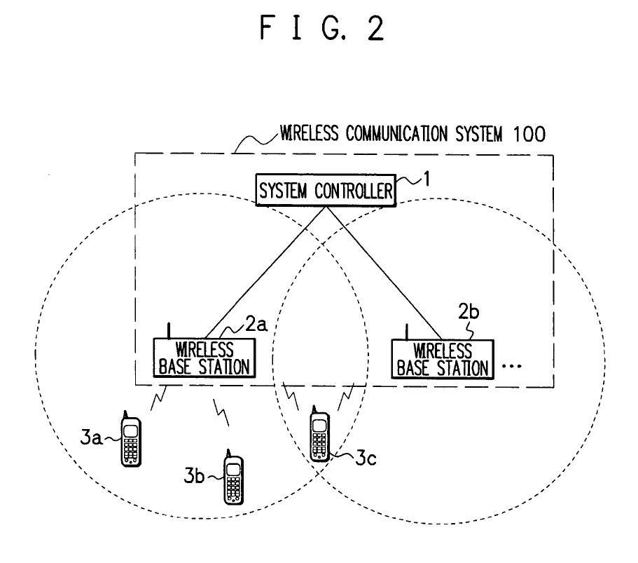

A wireless communication system 100 includes a system controller 1, wireless base stations 2 (2a, 2b, and so on) or access points (AP) connected to the system controller 1, and the base stations wirelessly communicate with wireless communication terminals 3 as shown in FIG. 2.

The system controller 1 carries out in the system 100 various control operations (for example, handover between base stations 2).

The system 100 conducts multi-rate communication and supports a plurality of transmission rates for wireless communication between the base stations 2 and terminals 3.

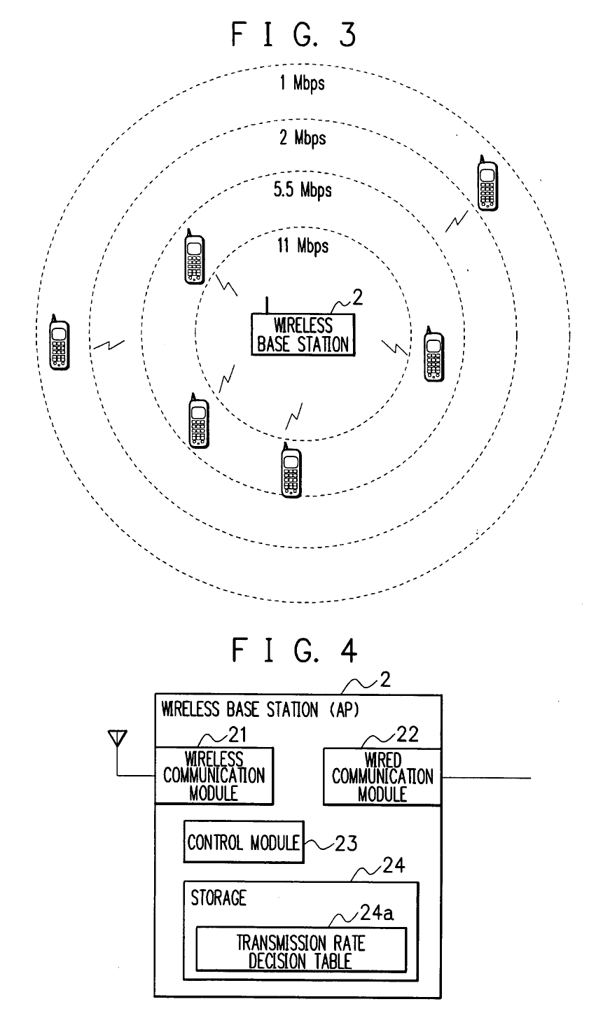

According to a basic property of the multi-rate communication, when the transmission rate is lowered, the distance of communication gets longer. As can be seen in FIG. 3, the wireless base station 2 communicates with a nearby wireless terminal 3 with a higher transmission rate. As a wireless terminal 3 goes farther, the base station 2 uses lower transmission rates. As a result, it is possible to efficiently carry out the wireless communication in a wide area.

As shown in FIG. 4, the base station 2 includes a wireless communication module 21 to conduct radio communication with the terminals 3 and other devices, a wired communication module 22 to carry out wired communication with the system controller 1 and the like, a control model 23 to supervise operations of the base station 2, and a storage section 24 to store a transmission rate decision table 24a and the like.

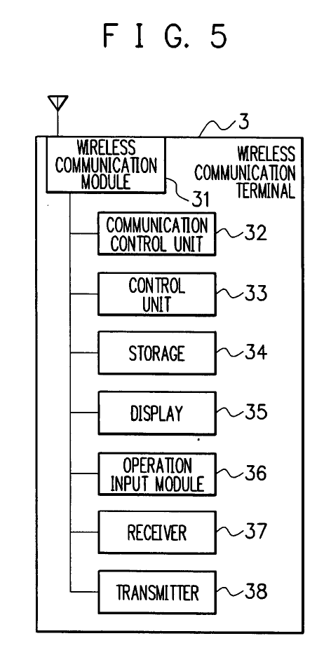

As shown in FIG. 5, the terminal 3 includes a wireless communication module 31 for conducting wireless communication with the base stations 2 and the like, a communication control module 32 to carry out communication control for communication of the wireless communication module 31, a control module 33 to control overall operations of the terminal 3, a display 35 to display various information pieces, an operation input module 36 to receive input items from a user, and a receiver 37 and a transmitter 38 to conduct calls using sound and voice.

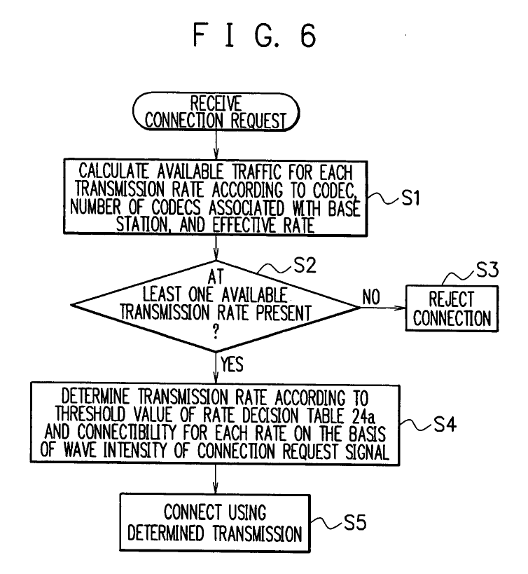

Referring next to the flowchart of FIG. 6, description will be given of operations to establish communication in system 100.

When a connection request is received from a terminal 3, the base station 2 calculates available traffic for each transmission rate (step S1).

To calculate the available traffic, the base station 2 continuously monitors the type of a coder-decoder (codec, i.e., a coding and decoding unit) employed by each terminal belonging to the base station 2, and the number of codecs associated with the base station 2.

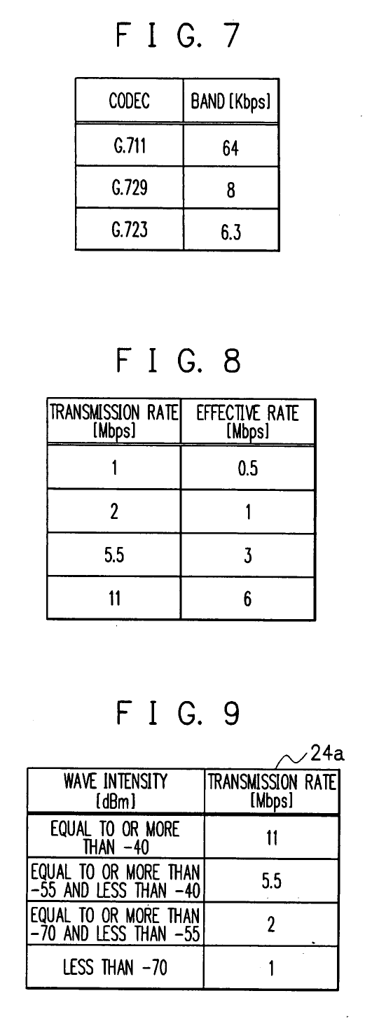

FIG. 7 shows a relationship determined beforehand between a codec type, and a band per one terminal that uses the codec type (a bit rate, i.e., the amount of data bits to be transmitted per second). Therefore, according to the codec type of the terminal associated with the base station 2 for each transmission rate, and the number of terminals using the codec, the base station 2 calculates a band to be used for each transmission rate.

A relationship between effective rates and transmission rates is defined in advance, for example, as shown in FIG. 8. Based on the table of FIG. 8, the available traffic is estimated as a difference given by the subtraction of a band currently used by the terminal 3 from the associated effective rate.

Based on the available traffic calculated for each transmission rate, the base station 2 knows whether a terminal can be added at a certain transmission rate, that is, whether the traffic is equal to or less than a predetermined connectibility threshold value (step S2).

If the connection capacity of the base station 2 has insufficient marginal or available traffic to connect one more terminal at a certain transmission rate (no in step S2), the base station 2 rejects the connection request and disconnects the communication (step S3).

If it is possible to connect at least one additional terminal with at least one of the transmission rates, the controller 23 of the base station 2 acquires information of electric wave intensity of signals received from the communication module 21. By referring to the rate decision table 24a exemplified in FIG. 9, the base station 2 determines a transmission rate corresponding to the wave intensity (step S4). If the communication is possible at the transmission rate, the base station 2 connects the terminal for communication using the transmission rate (step S5).

FIG. 9 shows an example of a transmission rate decision table 24a to determine a transmission rate according to the wave intensity of signals from the terminal 3.

If it is determined that there does not exist a sufficient traffic margin for the transmission rate, which was obtained from the rate decision table 24a and the electric wave intensity, the base station 2 tries to establish communication at a second transmission rate having a sufficient traffic margin. In this case, a transmission rate may be as high as possible, or an order of priority may be given in advance to the transmission rates.

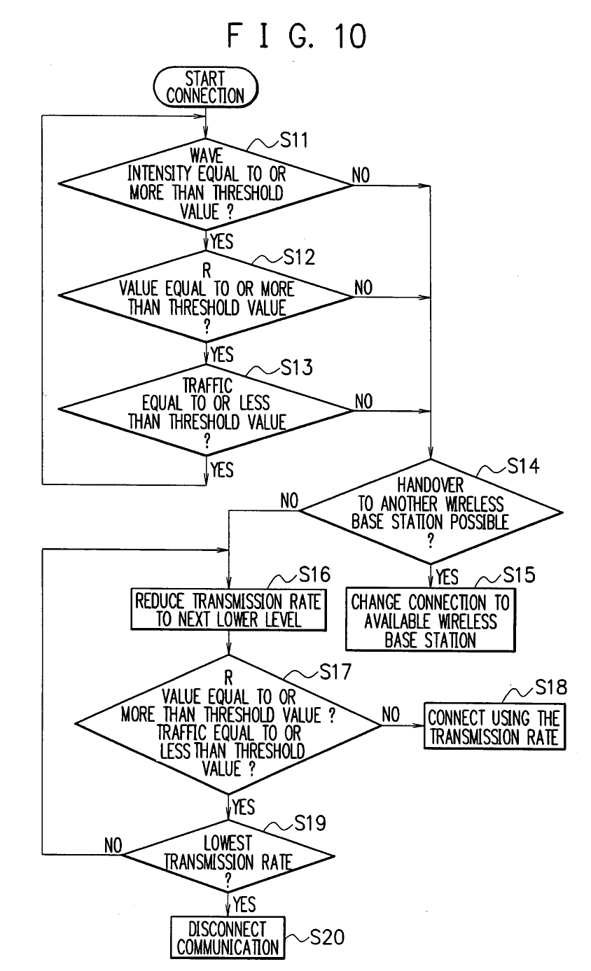

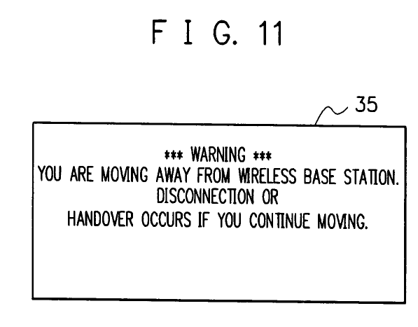

Referring now to the flowchart of FIG. 10, description will be given of an operation during the communication.

After the terminal is connected, the controller 23 continuously attains from the communication module 21 the wave intensity, the R value (calculated using sound quality, delay, echo, and the like according to a calculation formula of E-model), and communication traffic for each wireless communication terminal.

If the wave intensity and the R value each are equal to or more than the predetermined quality threshold values, and the traffic is equal to or less than a predetermined quality value, the base station 2 continues communication (yes in steps S11, S12, and S13).

If either the wave intensity or the R value is less than the predetermined quality threshold value, or if the traffic is more than the predetermined quality value, the base station 2 issues a query to the system controller 1 to determine whether the wireless communication with the terminal 3 in the connected state can be handed over to a second wireless base station (step S14).

If there exists such second wireless base station 2, the communication is handed over to the second base station 2 (step S15).

Otherwise, the base station 2 selects a next lower transmission rate for the handover (steps S16 to S19). If the selected transmission rate meets the conditions of the threshold values described above, the base station 2 establishes communication at the transmission rate (steps S17 and 18). If the lowest transmission rate does not satisfy the conditions (yes in step S119), the base station 2 disconnects the communication with the terminal 3 (step S20).

If the wave intensity or the R value lowers to a value near the associated threshold value at step S11 or S12, the base station 2 sends a warning message to the terminal 3. The message may be set in a predetermined packet for transmission, for example, in a control frame to be delivered from the base station 2 to the terminal 3.

When the warning notification is received by the terminal 3, the control module 33 displays images or messages as shown in FIG. 11 or produces sound and voice via a speaker of the receiver 37 to thereby notify the user of the difficulty in the connection due to the deterioration of the communication quality.

As above, the number of terminals simultaneously communicating with the base station is not fixed and the connection is established based on judgment whether a terminal can be newly added while the predetermined communication quality is maintained. Therefore, the ability for simultaneous connections of the base station 2 is flexibly utilized. The idle capacity of a base station, which has been wasted so far, is used to establish more simultaneous connections between the base station and wireless communication terminals.

As a result, even when the transmission rate dynamically changes in the multi-rate communication system and the occupied band cannot be easily calculated, it is possible to flexibly utilize the simultaneous connection capacity of the base station 2 as the communication quality in the wireless communication is maintained.

Particularly, when the terminal 3 is a wireless audio terminal conducting audio communication using sound and voice, a larger number of terminals 3 can be simultaneously connected to the base station 2 for simultaneous calls while the predetermined quality of sound and voice communication is maintained.

That is, previously, when the wave intensity worsened during a call in the conventional system, the call was handed over or was disconnected based only on the intensity of electric waves. In contrast, the present embodiments take also into account the quality of sound and voice during a call. When the audio quality falls below a predetermined level, the connection is handed over or disconnected. As a result, it is possible to keep the audio quality suitable for the user during the call.

In addition, since the present embodiments use an R-value, which is quite similar to the actual evaluation of quality of sound and voice, the control of wireless communication including the handover gives less frustration to a user.

In this way, by using information and communication data communicated by the wireless base station 2 in the system, it is possible to automatically determine the number of calls and the transmission rates that are required to secure the quality of sound and voice under various circumstances.

Also, since the wireless communication terminal 3 displays warning messages or images when the electric wave intensity or the R value lowers to a value near the predetermined quality value, it is possible to issue to the user, for example, a message like “do not move from your place if the handover of communication is not desired”.

This is because when the electric wave intensity or the R value lowers to a value near the predetermined quality value, it is likely that the user of the terminal 3 is moving away from the base station 2 that is communicating with the terminal 3. In this case, if the user does not desire the handover, the message advantageously urges the user not to move any more.

The embodiments described above are only exemplary embodiments in accordance with the present invention. The present invention is not restricted by these embodiments. The embodiments can be modified and changed in various ways according to the technological idea of the present invention.

For example, in the description of the embodiments, the transmission rates are determined on the basis of the wave intensity of received signals. However, the judge criterion is not restricted by the embodiments and any judge criterion may be employed only if it is possible to determine according to the criterion whether the favorable communication state is secured. For example, there may be adopted a configuration in which the transmission rates are determined on the basis of the Signal to Noise Ratio (SNR) of the received signal.

In addition, in the description of the embodiments, the R value is employed as a parameter for the quality of sound and voice. The standard for judgment is not restricted by these embodiments. Any desired standard may be used so long as the quality of sound and voice can be determined according to the standard. For example, it is possible to adopt, PESQ (Perceptual Evaluation of Speech Quality) defined in ITU-T P.862, which is a test for higher quality of sound and voice.

Although wired communication is assumed between the system control unit 1 and the wireless base station 2 in the above embodiments, any scheme may be employed so long as communication is established. For example, wireless communication may be applied.

The modules and functions arranged in the wireless base station 2 in the embodiments may be realized by the whole wireless communication system 100. For example, the system control unit may include the modules and functions. Or, the modules and functions may be realized through cooperation of the system control unit and the wireless base station.

Also, in the exemplary embodiments, wireless base stations are connected to one system control unit. However, so long as the handover is made between wireless base stations, a plurality of system control units and wireless base stations may be coupled.

It is also possible that a program to implement the processing procedures that execute the embodiments of the wireless communication system is recorded in a recording medium. The recording medium is installed in a computer of the wireless communication system and the functions of the embodiments are implemented when the program is executed by the Central Processing Unit (CPU) of the computer.

In this situation, the present invention is also applicable even when information items including the program are supplied to an output device from the recording medium or from an external recording medium via a network.

That is, the program code read from the recording medium realizes the novel functions of the present invention. The recording medium having recorded the program code and the signals read from the recording medium are included in the scope of the present invention.

The recording medium may be, for example, a floppy (registered trademark) disk, a hard disk, an optical disk, a magnetic optical disk, a Compact Disk-Read Only Memory (CD-ROM), a magnetic tape, a nonvolatile memory card, an ROM, or an Electrically Erasable Programmable ROM (EPPROM).

By use of the program in accordance with the present invention, the wireless communication system and the wireless base stations controlled by the program can be made to achieve the functions of the wireless communication system.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

While the invention has been described in terms of several exemplary embodiments, those skilled in the art will recognize that the invention can be practiced with modification within the spirit and scope of the appended claims.

Further, it is noted that Applicant's intent is to encompass equivalents of all claim elements, even if amended later during prosecution.

What is claimed is:

1. A wireless communication system including one or more wireless base stations, each controlling connection for wireless communication with wireless communication terminals, and a system control unit for conducting various control operations for the communication in the base stations, the system supporting a plurality of transmission rates, comprising:
a communication state acquiring section that continuously acquires a wireless communication state for each of the transmission rates; and
a connection grant decision section that determines, based on the wireless communication state, a grant or rejection of a connection for a wireless communication terminal.

2. The wireless communication system in accordance with claim 1, wherein:
the communication state acquiring section acquires at least information of traffic for each transmission rate in the wireless base station; and
the connection grant decision section determines, based on the information of traffic, the grant or rejection of connection for the wireless communication terminal.

3. The wireless communication system in accordance with claim 2, wherein the connection grant decision section determines, based on whether the information of traffic is equal to or less than a connectibility threshold value beforehand determined for at least one transmission rate, the grant or rejection of connection for the wireless communication terminal.

4. The wireless communication system in accordance with claim 1, wherein:
the communication state acquiring section calculates an amount of transmission data per second for each transmission rate by a use of an amount of transmission data per second of each wireless communication terminal belonging to one wireless base station and a number of wireless communication terminals belonging to the wireless base station with the amount of transmission data per second; and
the connection grant decision section determines, based on the amount of transmission data per second for each transmission rate and an effective rate beforehand determined for each transmission rate, grant or rejection of connection for the wireless communication terminal.

5. The wireless communication system in accordance with claim 1, further comprising communication quality keeping section that acquires, from the communication state acquiring section, information of communication quality in communication established in advance and conducting a changeover of connection according to the information of communication quality.

6. The wireless communication system in accordance with claim 5, wherein the communication quality keeping section conducts a changeover of connection to a second connectable base station if the information of communication quality indicates a quality lower than a predetermined quality and lowers the transmission rate for the connection or disconnects the connection if the information of communication quality indicates the quality to be lower than the predetermined quality and there does not exists any connectable second wireless base station.

7. The wireless communication system in accordance with claim 5, wherein the communication quality information includes information of sound and voice in a call using sound and voice.

8. The wireless communication system in accordance with claim 5, wherein the communication quality information includes information of wave intensity of electric waves received from a wireless communication terminal.

9. The wireless communication system in accordance with claim 5, wherein the communication quality information includes information of traffic in the wireless base station.

10. The wireless communication system in accordance with claim 5, further comprising a warning transmitting section that transmits, if the information of communication quality lowers to a predetermined quality, warning notifying information to a wireless communication terminal conducting wireless communication with the communication quality.

11. A wireless communication terminal, comprising the warning notifying section that conducts warning notification if the warning notifying information is received from the warning transmitting section of the wireless communication system, in accordance with claim 10.

12. A wireless base station for supporting a plurality of transmission rates and controlling wireless communication with a wireless communication terminal, comprising:
a communication state acquiring section that continuously acquires a wireless communication state for each of the transmission rates; and
a connection grant decision section that determines, based on the wireless communication state, a grant or rejection of connection for a wireless communication terminal.

13. The wireless base station in accordance with claim 12, wherein:
the communication state acquiring section acquires at least information of traffic for each transmission rate in the wireless base station; and
the connection grant decision section determines, based on the information of traffic, the grant or rejection of connection for the wireless communication terminal.

14. The wireless base station in accordance with claim 13, wherein the connection grant decision section determines, based on whether the information of traffic is equal to or less than a connectibility threshold value beforehand determined for at least one transmission rate, the grant or rejection of connection for the wireless communication terminal.

15. The wireless base station in accordance with claim 12, wherein:
the communication state acquiring section calculates an amount of transmission data per second for each transmission rate by a use of an amount of transmission data per second of each wireless communication terminal belonging to the wireless base station and a number of wireless communication terminals belonging to the wireless base station with the amount of transmission data per second; and
the connection grant decision section determines, based on the amount of transmission data per second for each transmission rate and an effective rate beforehand determined for each transmission rate, the grant or rejection of connection for the wireless communication terminal.

16. The wireless base station in accordance with claim 12, further comprising a communication quality keeping section that acquires, from the communication state acquiring section, information of communication quality in communication established in advance and conducting a changeover of connection according to the information of communication quality.

17. The wireless base station in accordance with claim 16, wherein the communication quality keeping section conducts a changeover of connection to a second connectable base station if the information of communication quality indicates a quality lower than a predetermined quality and lowers the transmission rate for the connection or disconnects the connection if the information of communication quality indicates the quality to be lower than the predetermined quality and there does not exists any connectable second wireless base station.

18. The wireless base station in accordance with claim 16, wherein the communication quality information includes information of sound and voice in a call using sound and voice.

19. The wireless base station in accordance with claim 16, wherein the communication quality information includes information of wave intensity of electric waves received from a wireless communication terminal.

20. The wireless base station in accordance with claim 16, wherein the communication quality information includes information of traffic in the wireless base station.

21. The wireless base station in accordance with claim 16, further comprising a warning transmitting section that transmits, if the information of communication quality lowers to a predetermined quality, warning notifying information to a wireless communication terminal conducting wireless communication with the communication quality.

22. A method of determining number of simultaneous connections for use with a wireless communication system including one or more wireless base stations each controlling wireless communication with wireless communication terminals, and a system control unit for conducting various control operations for the communication in the base stations, the system supporting a plurality of transmission rates, the method comprising:
a communication state acquiring step of continuously acquiring a wireless communication state for each of the transmission rates; and
a connection grant decision step of determining, based on the wireless communication state acquired in the communication state acquiring step, a grant or rejection of connection for a wireless communication terminal.

23. The method in accordance with claim 22, wherein:
the communication state acquiring step comprises acquiring at least information of traffic for each transmission rate in the wireless base station; and
the connection grant decision step comprises determining, based on the information of traffic acquired in the communication state acquiring step, the grant or rejection of connection for the wireless communication terminal.

24. The method in accordance with claim 23, wherein the connection grant decision step comprises determining, based on whether the information of traffic is equal to or less than a connectibility threshold value beforehand determined for at least one transmission rate, the grant or rejection of connection for the wireless communication terminal.

25. The method in accordance with in accordance with claim 22, wherein:
the communication state acquiring step comprises calculating an amount of transmission data per second for each transmission rate by use of an amount of transmission data per second of each wireless communication terminal belonging to one wireless base station and a number of wireless communication terminals belonging to the wireless base station with the amount of transmission data per second; and
the connection grant decision step comprises determining, based on the amount of transmission data per second for each transmission rate and an effective rate beforehand determined for each transmission rate, the grant or rejection of connection for the wireless communication terminal.

26. The method in accordance with claim 22, further comprising:
a communication quality keeping step of acquiring information of communication quality in communication established in advance; and
a communication quality keeping step of conducting a changeover of connection according to the information of communication quality.

27. The method in accordance with claim 26, wherein the communication quality keeping step comprises conducting a changeover of connection to a second connectable base station if the information of communication quality indicates a quality lower than a predetermined quality and lowering the transmission rate for the connection or disconnecting the connection if the information of communication quality indicates the quality lower than the predetermined quality and there does not exists any connectable second wireless base station.

28. The method in accordance with claim 26, wherein the communication quality information includes information of sound and voice in a call using sound and voice.

29. The method in accordance with claim 26, wherein the communication quality information includes information of wave intensity of electric waves received from a wireless communication terminal.

30. The method in accordance with claim 26, wherein the communication quality information includes information of traffic in the wireless base station.

31. The method in accordance with claim 26, further comprising a warning transmitting step of transmitting, if the information of communication quality acquired in the communication state acquiring step lowers to the predetermined quality, warning notifying information to a wireless communication terminal conducting wireless communication with the communication quality.

32. A computer program for a wireless communication system including one or more wireless base stations each controlling a connection for wireless communication with wireless communication terminals, and a system control unit for conducting various control operations for the communication in the base stations, the system supporting a plurality of transmission rates, the program causing a computer to perform:
a communication state acquiring processing for continuously acquiring a wireless communication state for each of the transmission rates; and
a connection grant decision processing for determining, based on the wireless communication state acquired by the communication state acquiring processing, a grant or rejection of a connection for a wireless communication terminal.

33. The computer program in accordance with claim 32, wherein:
the communication state acquiring processing comprises acquiring at least information of traffic for each transmission rate in the wireless base station; and
the connection grant decision processing comprises determining, based on the information of traffic acquired by the communication state acquiring processing, the grant or rejection of the connection for the wireless communication terminal.

34. The computer program in accordance with claim 33, wherein the connection grant decision processing comprises determining, based on whether the information of traffic is equal to or less than a connectibility threshold value beforehand determined for at least one transmission rate, the grant or rejection of connection for the wireless communication terminal.

35. The computer program in accordance with in accordance with claim 32, wherein:
the communication state acquiring processing comprises calculating an amount of transmission data per second for each transmission rate by use of an amount of transmission data per second of each wireless communication terminal belonging to one wireless base station and a number of wireless communication terminals belonging to the wireless base station with the amount of transmission data per second; and
the connection grant decision processing comprises determining, based on the amount of transmission data per second for each transmission rate and an effective rate beforehand determined for each transmission rate, the grant or rejection of the connection for the wireless communication terminal.

36. The computer program in accordance with claim 32, further causing a computer to perform:
a communication quality keeping processing for acquiring information of communication quality in communication established in advance; and
a communication quality keeping processing for conducting a changeover of connection according to information of communication quality.

37. The computer program in accordance with claim 36, wherein the communication quality keeping processing comprises conducting a changeover of connection to a second connectable base station if the information of communication quality indicates quality lower than a predetermined quality and lowering the transmission rate for the connection or disconnecting the connection if the information of communication quality indicates the quality to be lower than the predetermined quality and there does not exist any connectable second wireless base station.

38. The computer program in accordance with claim 36, wherein the communication quality information includes information of sound and voice in a call using sound and voice.

39. The computer program in accordance with claim 36, wherein the communication quality information includes information of wave intensity of electric waves received from a wireless communication terminal.

40. The computer program in accordance with claim 36, wherein the communication quality information includes information of traffic in the wireless base station.

41. The computer program in accordance with claim 36, further causing a computer to perform warning transmitting processing for transmitting, if the information of communication quality acquired in the communication state acquiring processing lowers to a predetermined quality, warning notifying information to a wireless communication terminal conducting wireless communication with the communication quality.
